(19) United States
(12) Patent Application Publication
(10) Pub. No.: US 2008/0080504 A1
(43) Pub. Date: Apr. 3, 2008

(54) SYSTEM AND METHOD FOR MANAGING FLOW OF A PLURALITY OF PACKETS IN A LOSSLESS COMMUNICATION NETWORK

(76) Inventors: Mircea Gusat, Langnau (CH); Cyriel Johan Agnes Minkenberg, Gutenswil (CH); Wolfgang Emil Denzel, Langnau am Albis (CH); Patricia Maria Sagmeister, Adliswil (CH); Andreas Christian Doring, Adliswil (CH); Thomas Schlipf, Holzgerlingen (DE); Maria Gabrani, Gattikon (CH)

Correspondence Address: IBM CORPORATION, T.J. WATSON RESEARCH CENTER, P.O. BOX 218, YORKTOWN HEIGHTS, NY, 10598, US

(21) Appl. No.: 11/536,101

(22) Filed: Sep. 28, 2006

(51) Int. Cl. H04L 12/56

(52) U.S. Cl. 370/392; 370/235; 370/412

(57) ABSTRACT

A method and system for managing flow of a plurality of packets in a lossless communication network interconnected by a plurality of switching-nodes is provided. The method includes creating a plurality of virtual-queues. Each virtual-queue corresponds to an output port of a switching-node. Thereafter, each packet is assigned to a virtual-queue. A packet is assigned to a virtual-queue based on information stored in a header of the packet.

### FIELD OF THE INVENTION

The present invention generally relates to a communication network. More specifically, the present invention relates to managing flow of a plurality of packets in a lossless communication network.

### BACKGROUND OF THE INVENTION

In a lossless communication network, a source-node communicates with a destination-node through one or more switching-nodes. Examples of a lossless communication network may include, but are not limited to Infiniband (IBA), and Ethernet. The source-node includes a plurality of queue-pairs. Each queue-pair includes a send-queue and a receive-queue. The source-node transmits data from one or more send-queues in the form of a plurality of packets to a switching-node. The switching-node receives each packet transmitted by the source-node through one or more input ports. Thereafter, switching-node transmits each packet to a corresponding destination-node based on the address in the header of a corresponding packet. A packet is transmitted from an output-port dedicated for the destination-node.

However, if one or more destination-nodes stops responding and/or slows down, then the switching-node suffers from hogging and blocking. This further leads to creation of saturation-trees in the lossless communication network.

### SUMMARY OF THE INVENTION

An object of the present invention is to provide a method and system to manage flow of a plurality of packets in a lossless communication network.

Another object of the present invention is to provide a method and system to create a plurality of virtual-queues corresponding to the output-ports of a switching-node.

Yet another object of the present invention is to provide a method and system to prevent hogging, and blocking in a switching node and creation of saturation trees in the lossless communication network.

The above listed objectives are achieved by providing a method and system for managing flow of a plurality of packets in a lossless communication network interconnected by a plurality of switching-nodes. The method includes creating a plurality of virtual-queues. Each virtual-queue corresponds to an output port of a switching-node. Thereafter, each packet is assigned to a virtual-queue. A packet is assigned to a virtual-queue based on information stored in a header.

### BRIEF DESCRIPTION OF THE DRAWINGS

The foregoing objects and advantages of the present invention for managing flow of a plurality of packets in a communication network may be more readily understood by one skilled in the art with reference being had to the following detailed description of several preferred embodiments thereof, taken in conjunction with the accompanying drawings wherein like elements are designated by identical reference numerals throughout the several views, and in which:

FIG. 1 is a block diagram showing an environment (that is exemplary) for the present invention to function.

FIG. 2 is a block diagram showing a system for managing flow of a plurality of packets in a lossless communication network, in accordance with an embodiment of the present invention.

FIG. 3 is a block diagram showing modules of an organizer for assigning each packet to a virtual queue, in accordance with an embodiment of the present invention.

FIG. 4 is a flowchart of a method for managing flow of a plurality of packets in a lossless communication network, in accordance with an embodiment of the present invention.

FIG. 5 is a flowchart of a method for managing flow of a plurality of packets in a lossless communication network, in accordance with another embodiment of the present invention.

### DETAILED DESCRIPTION OF THE DRAWINGS

Before describing in detail embodiments that are in accordance with the present invention, it should be observed that the embodiments reside primarily in combinations of method steps and system components related to systems and methods for managing flow of a plurality of packets in a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein.

Various embodiments of the present invention provide method and system to manage the flow of a plurality of packets in a lossless communication network. The lossless communication network is interconnected by a plurality of switching-nodes. Each switching-node includes one or more output-ports. Each output-port is dedicated for a destination-node in the lossless communication network.

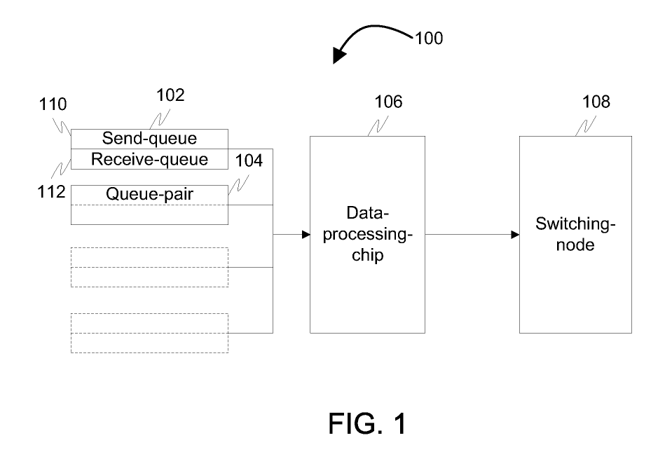

FIG. 1 is a block diagram showing an environment 100 (that is exemplary) for the present invention to function. Environment 100 includes a plurality of queue-pairs (for example, a queue-pair 102, and a queue-pair 104) a data-processing-chip 106, and a switching-node 108. A source-node (not shown in FIG. 1) includes the plurality of queue-pairs. Each queue includes a send-queue and a receive-queue. For example, queue-pair 102 includes a send-queue 110, and a receive-queue 112. Each send-queue includes a Work Queue Element (WQE). A WQE of a send-queue includes descriptors corresponding to data in the send-queue. The descriptors in a WQE corresponding to data in a send-queue includes address of a destination-node of the data. The descriptor further includes information corresponding to the data to be sent and protection information for the data. Information corresponding to the data, for example, may be memory address for the data and the length of the data. The source-node sends data to data-processing-chip 106. Data-processing-chip 106 processes the data and converts the data into a plurality of packets. Thereafter, data-processing-chip 106 transmits the plurality of packets to switching-node 108. The plurality of packets are received through one or more input-ports of switching-node 108. Switching-node 108 switches the plurality of packets to one or more destination nodes (not shown in FIG. 1) through one or more output-ports of switching-node 108 based on the information stored in the header of each packet.

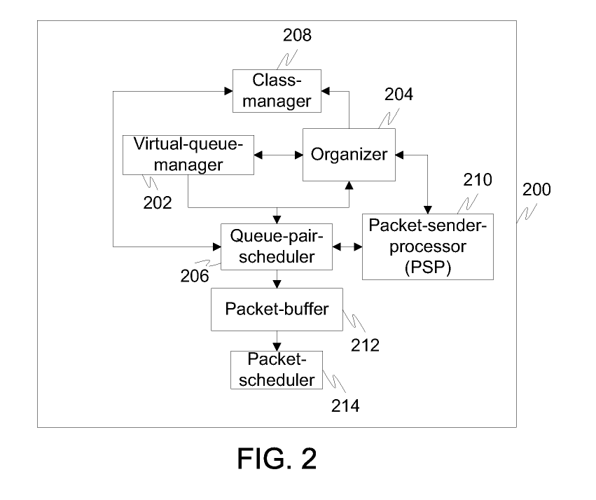

FIG. 2 is a block diagram showing a system 200 for managing a plurality of packets in a lossless communication network, in accordance with an embodiment of the present invention. In various embodiments of the present invention, system 200 may be a data-processing-chip. Those of skill in the art will, however, appreciate that the present invention is not limited to the above-mentioned example, and the present invention shall have full scope of the field.

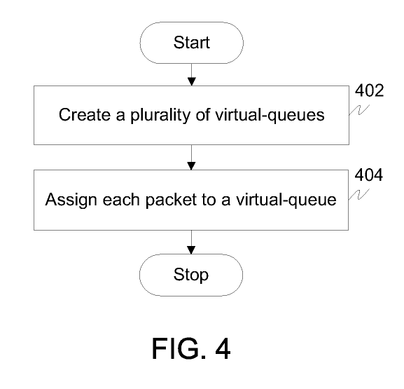

System 200 includes a virtual-queue-manager 202 and an organizer 204. Virtual-queue-manager 202 creates a plurality of virtual-queues in a queue-pair-scheduler 206. The number of virtual-queues is equal to the number of output-ports of switching-node 108. For example, if switching-node 108 has five output-ports, then five virtual-queues are created inside queue-pair-scheduler 206. Each virtual-queue corresponds to an output-port of switching-node 108 and is dedicated to the corresponding output-port. This is further explained in detail in conjunction with FIG. 4.

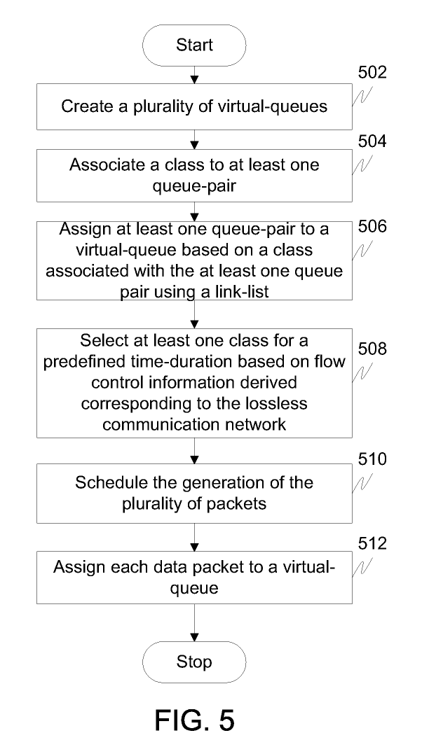

After virtual-queue-manager 202 creates the plurality of virtual-queues, a class-manager 208 associates a class to one or more queue-pairs. A class corresponds to one or more output-ports of switching-node 108. Class-manger 208 associates a class to one or more queue-pairs based on information stored in a descriptor in a WQE for data in one or more queue-pairs. This is further explained in conjunction with FIG. 5.

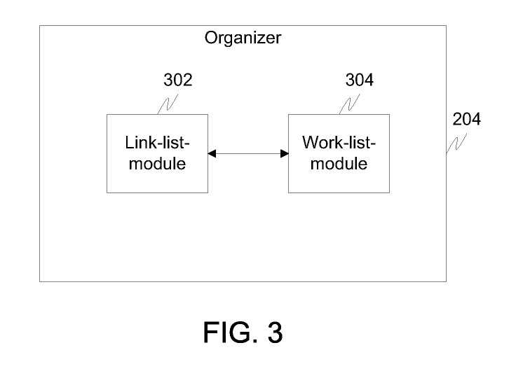

Thereafter, organizer 204 communicates with each of virtual-queue-manager 202 and queue-pair-scheduler 206 to assign one or more queue-pairs to a virtual-queue based on a class associated with one or more queue-pairs. Organizer 204 includes a link-list-module, which uses a link-list to assign one or more queue-pairs to a virtual-queue. The plurality of virtual-queues are organized using the link-list. Organizer 204 is further explained in detail in conjunction with FIG. 3. Thereafter, queue-pair-scheduler 206 selects one or more classes for a predefined time-duration based on flow control information derived corresponding to the lossless communication network. Therefore, by selecting one or more classes, queue-pair-scheduler 206 determines one or more queue-pairs for the predefined time-duration. The one or more queue-pairs, determined by queue-pair-scheduler 206, are associated with the selected one or more classes. The determined one or more queue-pairs are active-queue-pairs for the predefined time-duration. An active-queue-pair includes data that is used during current time duration. This is further explained in detail in conjunction with FIG. 5. Organizer 204 communicates with queue-pair-scheduler 206 to maintain a list of active-queue-pairs in a work-list. This is further explained in detail in conjunction with FIG. 5.

Queue-pair-scheduler 206 schedules the generation of the plurality of packets in one or more Packet-Sender-Processors (PSPs) (for example, PSP 210). PSP 210 generates the plurality of packets in the lossless communication network. The plurality of packets are generated from the data in each active-queue-pair for the predefined time-duration. This is further explained in detail in conjunction with FIG. 5.

Thereafter, organizer 204 communicates with PSP 210 to assign each packet generated by PSP 210 to a virtual-queue in queue-pair-scheduler 206 based on information stored in the header of each packet. This is further explained in detail in conjunction with FIG. 5. Queue-pair-scheduler 206 stores the plurality of packets in a packet-buffer 212. Packet-buffer 212 transmits the plurality of packets to a packet-scheduler 214 for a second scheduling. Packet-scheduler 214 schedules the plurality of packets received from packet-buffer 212 before transmission of the plurality of packets to switching-node 108. This is further explained in detail in conjunction with FIG. 5.

FIG. 3 is a block diagram showing modules of organizer 204 for assigning each packet to a virtual-queue, in accordance with an embodiment of the present invention. Organizer 204 includes a link-list-module 302 and work-list-module 304. Link-list-module 302 assigns a queue-pair to a virtual-queue based on a class associated with the queue-pair in a link-list. Each of the virtual-queue and the class are associated with an output-port of switching-node 108. Link-list-module 302 uses the link-list to organize the plurality of virtual-queues. For a virtual-queue, link-list-module 302 uses the link-list to link one or more queue-pairs assigned to the virtual-queue. In a set of queue-pairs assigned to a virtual-queue, each queue-pair points to address of a succeeding queue-pair. This is further explained in detail in conjunction with FIG. 5.

Work-list-module 304 maintains a list of active-queues in a work-list. An active-queue comprises data used during a predefined time-duration. Link-list-module 302 communicates with work-list-module 304 to link the active-queues in the link-list. This is further explained in detail in conjunction with FIG. 5

FIG. 4 is a flowchart of a method for managing flow of a plurality of packets in a lossless communication network, in accordance with an embodiment of the present invention. At step 402, virtual-queue-manager 202 creates a plurality of virtual-queues in queue-pair-scheduler 206. The number of virtual-queues is equal to the number of the output-ports of switching-node 108. Each virtual-queue corresponds to an output-port of switching-node 108 and is dedicated to the corresponding output-port. Therefore, one or more packets received by switching-node 108 from a virtual-queue are transmitted from an output-port corresponding to the virtual-queue to a destination-node. For example, if a first virtual-queue is dedicated to the first output-port of switching-node 108, then one or more packets received from the first virtual-queue are transmitted from the first output-port to a destination-node. In an embodiment of the present invention, a set of existing-virtual-queues are defined corresponding to switching-node 108. Therefore, one or more existing-virtual-queues in the set of existing-virtual-queues are partitioned to create the plurality of virtual-queues.

Thereafter, class-manager 208 associates a class to one or more queue-pairs. A class corresponds to one or more output-ports of switching-node 108. Class-manager 208 associates a class to one or more queue-pairs based on information stored in a descriptor in a WQE corresponding to data in one or more queue-pairs. This is further explained in conjunction with FIG. 5. After class-manager 208 associates a class to one or more queue-pairs, link-list-module 302 uses a link-list to assign a queue-pair to a virtual-queue based on a class associated with the queue-pair. The plurality of virtual-queues are organized using the link-list. This is further explained in conjunction with FIG. 5.

At step 404, organizer 204 assigns each packet to a virtual-queue. A packet is assigned to a virtual-queue based on information stored in the header of the packet. The information stored in a header of a packet includes the address of a destination-node. Therefore, a packet is assigned to a virtual-queue, which corresponds to an output-port of switching-node 108 dedicated for communication with the destination-node.

As the plurality of packets are scheduled for generation based on the flow control information of the lossless communication network, therefore, packets corresponding to destination-nodes that are not slow and are not clogged are generated first. This enables preventing clogging and blocking of switching-node 108. Further, as each packet is assigned to a virtual-queue, which corresponds to an output-port of switching-node 108, therefore, the scheduling of packets for transmission to one or more destination-nodes is not done in switching-node 108. Scheduling of packet in switching-node 108 may lead to reduced efficiency in communication in the lossless communication network

FIG. 5 is a flowchart of a method for managing flow of a plurality of packets in a lossless communication network, in accordance with another embodiment of the present invention. At step 502, virtual-queue-manager 202 creates a plurality of virtual-queue inside queue-pair-scheduler 206. The number of virtual-queues is equal to the number of the output-ports of switching-node 108. This has been explained in conjunction with FIG. 4.

Thereafter, at step 504, class-manager 208 associates a class to one or more queue-pairs based on information stored in the header of one or more packets in one or more queue-pairs. A class is associated with one or more output-ports of switching-node 108 and is dedicated to them. Equal numbers of ports of switching-node 108 may be associated with each class. For example, switching-node 108 has eight output-ports. Additionally, a first class and a second class are to be associated with the eight output-ports. Therefore, a first class may be associated with a first, a fourth, a fifth and a sixth output-port and the second class may be associated with a second, a third, a seventh and an eighth output-port of switching-node 108. In an embodiment of the invention, different number of ports of switching-node 108 may be associated with each class. For example, switching-node 108 has seven output-ports. In this case, the first class may be associated with the first, the fourth, the fifth and the sixth output-port and the second class may be associated with the second, the third, and the seventh output-port of switching-node 108.

In an exemplary embodiment of the present invention, the classes may be represented as equation 1:

C(k)=k div m (1)

### Where,

K=port index
m=number of ports in a class

Further, as each output-port is dedicated to a destination-node and the information stored in a descriptor in a WQE corresponding to data in a queue-pair, includes the address of a destination-node, therefore, if a descriptor in a WQE corresponding to data in a queue-pair includes address of a destination-node, then a class, which is associated with an output-port dedicated for the destination-node, is associated with the queue-pair. For example, queue-pair 102 includes a first set of data at a first time and a second set of data at a second time that succeeds the first time. A descriptor in a WQE corresponding to the first set of data in queue-pair 102 includes address of a first destination-node and a descriptor in a WQE for the second set of data in queue-pair 102 includes address of a second destination-node. A first output-port in switching-node 108 is dedicated for the first destination-node. Further, a first-class is associated with the first output-port. Therefore, the first-class is associated to queue-pair 102 at the first time. Similarly, at the second time, a second-class is associated to queue-pair 102. The second-class is associated with the second output-port, which is dedicated for a second destination-node.

After class-manager 208 associates a class to each queue-pair, organizer 204 uses a link-list to assign one or more queue-pairs to a virtual-queue based on a class associated with one or more queue-pairs at step 506. Each of the virtual-queue and the class are associated with an output-port of switching-node 108. The output-port is dedicated for a destination node, which is the destination of data in one or more queue-pairs. A descriptor in a WQE corresponding to the data includes the address of the destination-node. For example, a class is associated to queue-pair 102 based on the address of a destination-node in a descriptor in a WQE corresponding to the data in queue-pair 102. Thereafter, queue-pair 102 is assigned to a virtual-queue that corresponds to the output-port dedicated for the destination-node.

Link-list-module 302 uses the link-list to organize the plurality of virtual-queues. For a virtual-queue, the link-list is used to link one or more queue-pairs assigned to the virtual-queue. In a set of queue-pairs assigned to a virtual-queue, each queue-pair points to address of a succeeding queue-pair. Therefore, the link-list is used to select a succeeding queue-pair from the set of queue-pairs assigned to the virtual-queue. The succeeding queue-pair succeeds a queue-pair, which is currently being used by the virtual-queue. Further, a descriptor in a WQE corresponding to data in each queue-pair includes the address of the destination-node for which an output-port corresponding to the virtual-queue is dedicated. For example, each of queue-pair 102 and queue-pair 104 are assigned to a first virtual-queue. A link-list is used to link queue-pair 102 and queue-pair 104, such that, queue-pair 102 point to the address of queue-pair 104. Further, at a first time the first virtual-queue initially communicates with queue-pair 102. Thereafter, using the link-list, the first virtual-queue communicates with queue-pair 104.

After organizer 204 assigns one or more queue-pairs to a virtual-queue based on the class associated with one or more queue-pairs, queue-pair-scheduler 206 selects one or more classes for a predefined time-duration based on flow control information derived corresponding to the lossless communication network at step 508. In an embodiment of the present invention, one or more classes may be selected based on the load on each output-port of switching-node 108. The output-ports corresponding to one or more selected classes have lower loads as compared to other output-ports of switching-node 108. This enables balancing load on switching-node 108, as a result of which, no output-port of switching-node 108 is overloaded. For example, switching-node 108 has a first output-port, a second output-port, a third output-port, and a fourth output-port. Each of the first output-port and the second output-port are serving to their maximum load capacity, whereas the third output-port and the fourth output-port are serving below the maximum load capacity. Therefore, one or more classes corresponding to the third output-port and the fourth output-port are selected.

In another embodiment of the present invention, one or more classes are selected based on the frequency of use of each output-port of switching-node 108. Each selected class corresponds to a least frequently used output-port for transmitting packets in the communication network. For example, the second output-port and the third output-port are least frequently used for transmitting packets in the communication network. Therefore, one or more classes corresponding to the second output-port and the third output-port are selected.

Selecting one or more classes result in determining one or more queue-pairs for the predefined time-duration. The determined one or more queue-pairs are associated with the selected one or more classes. One or more queue-pairs that are determined are active-queue-pairs for the predefined time-duration. An active-queue-pair includes data that is used during ongoing time duration. Work-list-module 304 maintains a list of active-queue-pairs in a work-list. Active-queue-pairs listed in the work-list are used in a First-In-First-Out (FIFO) order by link-list-module 302. Link-list-module 302 links the active-queue-pairs in the order that they are determined corresponding to the selected classes in the link-list.

At step 510, queue-pair-scheduler 206 schedules the generation of the plurality of packets. The plurality of packets are generated in one or more PSPs. For this, queue-pair-scheduler 206 assigns the active-queue-pairs for the predefined time-duration to PSP 210. PSP 210 generates the plurality of packets in the lossless communication network. In an embodiment of the present invention, queue-pair-scheduler 206 selects a PSP, which was earlier not used to generated packets in the lossless communication network. The plurality of packets are generated from the data in each active-queue-pair for the predefined time-duration. In an embodiment of the present invention, a first active-queue-pair, which is listed first in the work-list, is assigned first to PSP 210 for generation of a first set of packets from the data in the first active-queue-pair. Further, as the active-queue-pairs for the predefined time-duration are linked in the link-list, therefore, after the first active-queue-pair, a second-active-queue-pair is assigned to PSP 210 for generation of a second set of packets from the data in the second active-queue-pair. Similarly, a third active-queue-pair, which is listed last in the link-list, is assigned last to PSP 210 to generate a third set of packets from the data in the third active-queue-pair. The first set of packets, the second set of packets, and the third set of packets combine to form the plurality of packets.

Thereafter, at step 512, organizer 204 assigns each packet generated by PSP 210 to a virtual-queue in queue-pair-scheduler 206. A packet is assigned to a virtual-queue based on the information stored in the header of the packet. Referring back to step 506, as organizer 204 assigned one or more queue-pairs to a virtual-queue based on a class associated with one or more queue-pairs, therefore, one or more packets generated by PSP 210 from data received from a queue-pair, which is assigned to a virtual-queue, are assigned to the virtual-queue. For example, a first set of packets is generated from data received from a first queue-pair and a second set of packets is generated from data received from a second queue-pair. Further, organizer 204 assigns the first queue-pair to a first virtual-queue and the second queue-pair to a second virtual-queue. Therefore, organizer 204 assigns a first set of packets to the first virtual-queue and the second set of packets to the second virtual-queue.

After organizer 204 assigns each packet generated by PSP 210 to a virtual-queue, queue-pair-scheduler 206 transmits the plurality of packets from each virtual-queue to packet-buffer 212. Thereafter, packet-scheduler 214 schedules the plurality of packets for transmission to switching-node 108. A Link-Protocol-Engine (LPE) transmits the plurality of packets to switching-node 108. A packet assigned to a virtual-queue, which corresponds to an output-port of switching-node 108 is transmitted to the output-port.

The plurality of packets are scheduled in packet-scheduler 214, because, in an embodiment of the present invention, queue-pair-scheduler 206 may schedule generation of a first-packet before a second-packet in PSP 210. However, the second-packet may be generated in PSP 210 before the first-packet and is therefore transmitted to packet-scheduler 214 before the first-packet. Therefore, packet-scheduler 214 schedules the transmission of the first-packet and the second-packet, such that, the first-packet is transmitted to switching-node 108 before the second-packet.

Various embodiments of the present invention provide method and system for managing flow of a plurality of packets in a lossless communication network. A plurality of virtual-queues are created corresponding to output-ports of the switching-node. Each virtual-queue corresponds to an output-port of the switching-node and is dedicated for the output-port. The plurality of packets are scheduled and assigned to the plurality of virtual-queues. Thereafter, the plurality of packets are scheduled for transmission directly to an output-port of the switching-node based on the destination-node of the packet. This prevents hogging, and blocking of the switching-node. Therefore, development of saturation trees is prevented in the lossless communication network. In a lossless communication network that uses link-level flow control, a saturation tree may be caused by a single point of congestion in a switching-node. The single point of congestion may fill buffers in preceding switching-nodes, thereby stalling more links and/or virtual channels on these links. Therefore, a filled buffer in a switching-node may stall one or more incoming links, which leads to formation of a saturation tree.

The method for managing flow of a plurality of packets in a lossless communication network, as described in the present invention or any of its components may be embodied in the form of a computing device. The computing device can be, for example, but not limited to, a general-purpose computer, a programmed microprocessor, a micro-controller, a peripheral integrated circuit element, programmable logic device and other devices or arrangements of devices, which are capable of implementing the steps that constitute the method of the present invention.

The computing device executes a set of instructions that are stored in one or more storage elements, in order to process input data. The storage elements may also hold data or other information as desired. The storage element may be in the form of a database or a physical memory element present in the processing machine.

The set of instructions may include various instructions that instruct the computing device to perform specific tasks such as the steps that constitute the method of the present invention. The set of instructions may be in the form of a program or software. The software may be in various forms such as system software or application software. Further, the software might be in the form of a collection of separate programs, a program module with a larger program or a portion of a program module. The software might also include modular programming in the form of object-oriented programming. The processing of input data by the computing device may be in response to user commands, or in response to results of previous processing or in response to a request made by another computing device.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for managing flow of a plurality of packets in a lossless communication network interconnected by a plurality of switching-nodes, the method comprising:
creating a plurality of virtual-queues, wherein each virtual-queue corresponds to an output-port of a switching-node; and
assigning each packet to a virtual-queue, wherein a packet is assigned to a virtual-queue based on information stored in a packet-header.

2. The method of claim 1, wherein creating the plurality of virtual-queues comprises associating a class to at least one queue-pair, a class corresponds to at least one output-port of the switching-node, wherein a class is associated to the at least one queue-pair based on information stored in a descriptor of a Work Queue Element (WQE) corresponding to data in the at least one queue-pair, wherein the information stored in the descriptor corresponds to a destination output-port of the switching-node, the destination output-port of the switching-node is one of the at least one output-port of the switching-node.

3. The method of claim 2 further comprising assigning at least one queue-pair to a virtual-queue based on a class associated with the queue-pair using a link-list, each of the virtual-queue and the class being associated with an output-port of the switching-node, the output port being destination of at least one packet of the at least one queue-pair.

4. The method of claim 3, wherein the plurality of virtual-queues are organized using the link-list.

5. The method of claim 4, wherein at least one class is selected for a predefined time-duration based on a flow control information derived corresponding to the switching-node, selecting the at least one class determines at least one queue-pair for the predefined time-duration, wherein the at least one queue-pair is associated with the at least one class.

6. The method of claim 5, wherein the at least one class is selected based on load of each output-port of the switching-node.

7. The method of claim 5, wherein the at least one class is selected based on the frequency of use of each output-port of the switching-node.

8. The method of claim 7, wherein each selected class corresponds to a less frequently used output-port of the switching-node.

9. The method of claim 5, wherein the at least one queue-pair determined corresponding to the selected the at least one class is an active-queue-pair for the predefined time-duration, an active-queue-pair comprises data used during a current time duration.

10. The method of claim 9, wherein a list of active-queue-pairs is maintained in a work-list, the active-queue-pairs listed in the work-list are used in a First-In-First-Out (FIFO) order.

11. The method of claim 1, wherein each queue in a set of existing virtual-queues is partitioned to create the plurality of virtual queues, the set of existing virtual-queues are already defined corresponding to a switching-node.

12. A system for managing flow of a plurality of packets in a lossless communication network interconnected using a plurality of switching-nodes, the system comprising:
a virtual-queue-manager, wherein the virtual queue manager creates a plurality of virtual-queues, each virtual-queue corresponds to an output port of a switching-node;
an organizer, wherein the organizer assigns each packet to a virtual-queue, a packet is assigned to a virtual-queue based on information stored in a packet-header.

13. The system of claim 12 further comprising a class-manager, the class-manager associating a class to at least one queue-pair, a class corresponds to at least one output-port of the switching-node, wherein a class is associated to the at least one queue-pair based on information stored in a descriptor of a Work Queue Element (WQE) corresponding to data in at least one queue-pair, wherein the information stored in the descriptor corresponds to a destination output-port of the switching-node, the destination output-port of the switching-node is one of the at least one output-port of the switching-node

14. The system of claim 12, wherein the organizer comprises:
a work-list-module, wherein the work-list-module maintains a list of active-queues in a work-list, wherein an active-queue comprises data used during a predefined time-duration; and
a link-list-module, wherein a link-list-module assigns a queue-pair to a virtual-queue based on a class associated with the queue-pair in the link-list, each of the virtual-queue and the class are associated with an output-port of the switching-node, wherein the output port is destination of at least one packet of the queue-pair.

15. The system of claim 12, further comprising at least one Packet-Sender-Processor (PSP), the at least one PSP generating the plurality of packets in the lossless communication network.

16. The system of claim 15, wherein a queue-pair-scheduler schedules the generation of the plurality of packets in the at least one PSP.

17. The system of claim 16, wherein the queue-pair-scheduler stores each packet generated in the at least one PSP in a packet-buffer.

18. The system of claim 17, wherein a packet-scheduler schedules the plurality of packets received from the packet-buffer before transmission to the switching-node.

19. A computer program product comprising a computer usable medium embodying computer usable code for managing flow of a plurality of packets in a lossless communication network, the computer program product comprising:
computer usable program code for creating a plurality of virtual-queues, wherein each virtual-queue corresponds to an output port of a switching-node; and
computer usable program code for assigning each packet to a virtual-queue, wherein a packet is assigned to a virtual-queue based on information stored in a packet-header.
